(19) United States
(12) Patent Application Publication
(10) Pub. No.: US 2024/0219305 A1
(43) Pub. Date: Jul. 4, 2024

(54) BIOLOGICAL SAMPLE ANALYZER

(71) Applicant: Sony Group Corporation, Tokyo (JP)

(72) Inventor: Katsutoshi Tahara, Tokyo (JP)

(73) Assignee: Sony Group Corporation, Tokyo (JP)

(21) Appl. No.: 18/570,391

(22) PCT Filed: Feb. 24, 2022
(86) PCT No.: PCT/JP2022/007481

§ 371 Date: Dec. 14, 2023

(30) Foreign Application Priority Data
Jun. 25, 2021 (JP) 2021-105554

(51) Int. Cl. G01N 21/64

(52) U.S. Cl. CPC G01N 21/6486; G01N 2021/6439; G01N 2021/6491

(57) ABSTRACT

A main object of the present disclosure is to provide a new method of coping with a case where the amount of incident light to a detection unit of a biological sample analyzer is large.

The present disclosure provides a biological sample analyzer including a light irradiation unit that irradiates a biological particle contained in a biological sample with light; a detection unit that detects light generated by the light irradiation; and an information processing unit that controls the light irradiation unit, in which the information processing unit determines whether a detection result of fluorescence by the detection unit satisfies a predetermined condition, and adjusts an output of light irradiation by the light irradiation unit according to the determination result. The detection unit includes one or more photodiodes, and the information processing unit can adjust the output of light irradiation by the light irradiation unit such that saturation of a signal does not occur in the detection unit.

### TECHNICAL FIELD

The present disclosure relates to a biological sample analyzer. More specifically, the present disclosure relates to a biological sample analyzer including a light irradiation unit that irradiates a biological particle contained in a biological sample with light and a detection unit that detects light generated by the light irradiation.

### BACKGROUND ART

For example, a particle population such as cells, microorganisms, and liposomes is labeled with a fluorescent dye, and the intensity and/or pattern of fluorescence generated from the fluorescent dye excited by irradiating each particle of the particle population with laser light is measured, thereby measuring the characteristics of the particles. As a representative example of a particle analyzer that performs the measurement, a flow cytometer can be mentioned.

The flow cytometer is a device that irradiates particles flowing in a line in a flow channel with laser light (excitation light) having a specific wavelength and detects fluorescence and/or scattered light emitted from each particle to analyze a plurality of particles one by one. The flow cytometer can convert light detected by the photodetector into an electrical signal, quantify the electrical signal, and perform statistical analysis to determine characteristics, for example, the type, size, structure, and the like of each particle.

Several methods related to output adjustment of the laser light have been proposed so far. For example, Patent Document 1 below discloses a fine particle measuring device and the like at least including: at least two light sources having different wavelength ranges; a detection unit configured to detect light from a fluorescence reference particle in accordance with excitation light from the light sources; and an information processing unit configured to compare, on the basis of information detected by the detection unit, a feature quantity of an output pulse based on a reference light source among the plurality of light sources with a feature quantity of an output pulse based on at least another light source among the plurality of light sources, and adjust an output of the another light source.

### CITATION LIST

### Patent Document

Patent Document 1: WO 2018/047441

### SUMMARY OF THE INVENTION

### Problems to be Solved by the Invention

In a case where the amount of incident light on the light receiving element included in the detection unit of the flow cytometer is too large, the signal may be saturated and cannot be used, or the signal may be saturated in the light receiving element itself and the signal may not be received. Therefore, a main object of the present disclosure is to provide a new method of coping with a case where the amount of incident light is large.

### Solutions to Problems

The present disclosure provides a biological sample analyzer including a light irradiation unit that irradiates a biological particle contained in a biological sample with light;
a detection unit that detects light generated by the light irradiation; and
an information processing unit that controls the light irradiation unit,
in which the information processing unit determines whether a detection result of fluorescence by the detection unit satisfies a predetermined condition, and adjusts an output of light irradiation by the light irradiation unit according to the determination result.

The detection unit includes one or more photodiodes, and the information processing unit can adjust the output of light irradiation by the light irradiation unit such that saturation of a signal does not occur in the detection unit.

The information processing unit can adjust the output of light irradiation by the light irradiation unit on the basis of Height data in the detection result of the fluorescence.

The information processing unit can adjust the output of light irradiation by the light irradiation unit using an adjustment coefficient set on the basis of Height data in the detection result of the fluorescence and a predetermined target value.

The light irradiation unit includes two or more laser light sources for coaxial irradiation, and the information processing unit can adjust outputs of the two or more laser light sources for coaxial irradiation, using a same adjustment coefficient.

The light irradiation unit includes two or more laser light sources for irradiation with different axes, and the information processing unit can adjust outputs of the two or more laser light sources for irradiation with the different axes independently of each other.

The detection unit includes one or more photodiodes, and the predetermined condition may be a condition set on the basis of a condition where saturation of a signal occurs in the detection unit.

In the determination, the information processing unit can determine whether Height data in the detection result of the fluorescence satisfies the predetermined condition.

The detection unit includes a plurality of fluorescence channels, and the information processing unit can refer to Height data of a fluorescence channel from which a maximum Height value is obtained from among the plurality of fluorescence channels, in the determination.

The information processing unit can determine whether the information processing unit has adjusted the output of the laser light source included in the light irradiation unit, and correct data related to scattered light generated by the light irradiation according to the determination result.

The data related to the scattered light can include Area data, Height data, or both the Area data and Height data of the scattered light generated by the light irradiation.

The data related to the scattered light can include Threshold data for specifying a biological particle as an analysis target.

The information processing unit can correct the data related to the scattered light using a correction coefficient set on the basis of laser power before output adjustment and laser power after output adjustment of any laser light source included in the light irradiation unit.

The information processing unit can determine whether the information processing unit has adjusted the output of the light irradiation by the light irradiation unit, and adjust a compensation matrix used in fluorescence correction according to the determination result.

The information processing unit can adjust one or more compensation values in the compensation matrix by using a change coefficient set on the basis of laser power before output adjustment and laser power after output adjustment of any laser light source included in the light irradiation unit.

The information processing unit may not perform the adjustment for a compensation value related to a pair of two fluorescent dyes using a laser light source on which output adjustment has been performed as excitation light.

The information processing unit can execute the adjustment on
a compensation value related to a pair of one fluorescent dye using a laser light source on which the output adjustment has been performed as excitation light and one fluorescent dye using a laser light source on which the output adjustment has not been performed as excitation light and/or
a compensation value related to a pair of two fluorescent dyes using a laser light source on which the output adjustment has not been performed as excitation light.

### BRIEF DESCRIPTION OF DRAWINGS

FIG. 1 is a diagram illustrating an example of noise data.

FIG. 2 is a view illustrating a configuration example of a biological sample analyzer of the present disclosure.

FIG. 3 illustrates an example of a block diagram of the biological sample analyzer according to the present disclosure.

FIG. 4 illustrates an example of a flowchart of an output adjustment process executed by the biological sample analyzer according to the present disclosure.

FIG. 5 is a view for describing coaxial irradiation and different-axis irradiation.

FIG. 6A is a diagram illustrating data output before an output adjustment process.

FIG. 6B is a diagram illustrating data output after an output adjustment process.

FIG. 7A is a diagram illustrating data output before an output adjustment process.

FIG. 7B is a diagram illustrating data output after an output adjustment process.

FIG. 8A is a diagram illustrating data output before an output adjustment process.

FIG. 8B is a diagram illustrating data output after an output adjustment process.

FIG. 9A illustrates an example of a compensation matrix before adjustment.

FIG. 9B illustrates an example of a compensation matrix after adjustment.

### MODE FOR CARRYING OUT THE INVENTION

Hereinafter, preferred modes for carrying out the present disclosure will be described. Note that embodiments described below illustrate representative embodiments of the present disclosure, and the scope of the present disclosure is not limited only to these embodiments. Note that the present disclosure will be described in the following order.
1. First embodiment (biological sample analyzer)
(1) Basic concept of present disclosure
(2) Configuration example
(3) Laser power adjustment
(4) Example 1 of adjustment process of laser power
(5) Example 2 of adjustment process of laser power
(6) Example 3 of adjustment process of laser power
(7) Adjustment of compensation matrix executed with laser power adjustment

### 1. First Embodiment (Biological Sample Analyzer)

### (1) Basic Concept of Present Disclosure

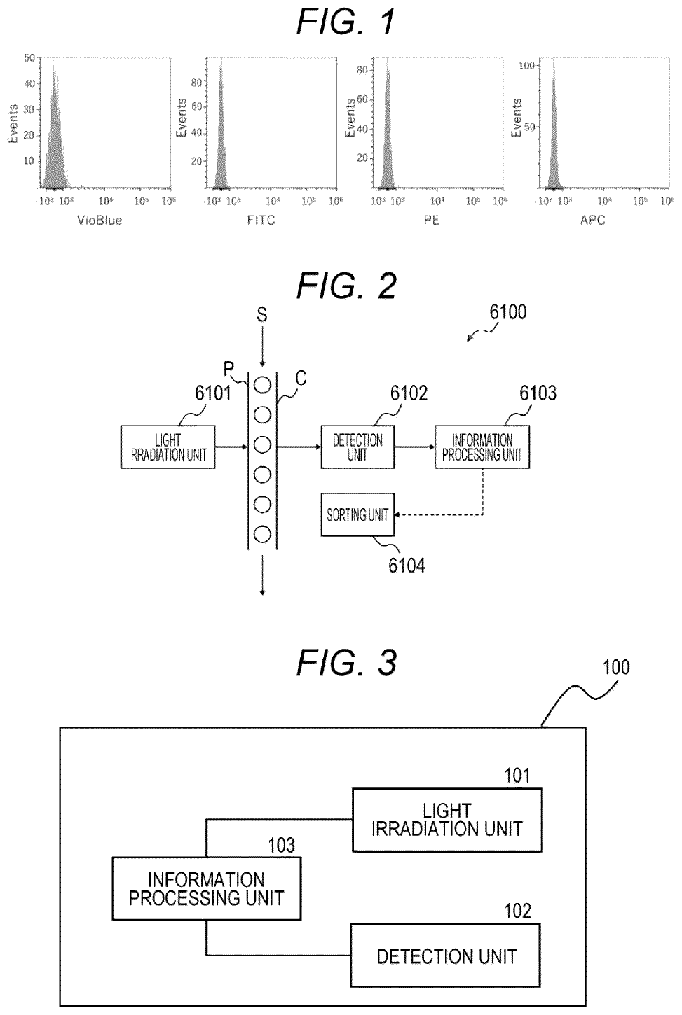

A light receiving element included in a detection unit of a flow cytometer has a predetermined dynamic range. However, a part of the dynamic range is occupied by noise. For example, regarding the flow cytometer having a dynamic range of about six digits, two or more digits are occupied by noise. FIG. 1 illustrates an example of noise data of each dye channel in a case where MPPC is used as the light receiving element. As illustrated in the figure, a partial range of the dynamic range is occupied by noise data. As described above, in the dynamic range of the light receiving element, the range that can be used for detecting the light generated from the particle is limited.

The dynamic range of the flow cytometer adopting a photomultiplier tube (hereinafter also referred to as “PMT”) as the light receiving element is, for example, about six digits. Regarding the flow cytometer, as described above, two or more digits of the dynamic range are occupied by noise, and the effective dynamic range for detecting the light generated from the biological particle is often four digits or less. However, the gain (Gain) can be changed by adjusting a voltage (also referred to as High Voltage, HV) applied to the PMT according to the amount of incident light. Therefore, even in a case where the amount of incident light is large, the signal can be detected without being saturated. Examples of the case where the amount of incident light is increased include a case where a cell as a detection target is large and a case where the expression level of the capture target substance by a fluorochrome-labeled antibody is strong.

As the light receiving element, a photodiode such as an avalanche photodiode (hereinafter also referred to as “APD”) or a multi-pixel photon counter (hereinafter also referred to as “MPPC”) can also be used. However, there is a case where the gain of these photodiodes is fixed or the gain cannot be changed as in the PMT. Therefore, in a case where the amount of incident light is large, the signal is saturated and cannot be used, or the signal is saturated in the light receiving element itself and cannot be received in some cases. The measurement result in a case where the signal is saturated may be invalid.

The biological sample analyzer according to present disclosure includes a light irradiation unit that irradiates a biological particle contained in a biological sample with light, a detection unit that detects light generated by the light irradiation, and an information processing unit that controls the light irradiation unit. Here, the information processing unit may be configured to determine whether or not a detection result of fluorescence by the detection unit satisfies a predetermined condition, and adjust an output of light irradiation by the light irradiation unit according to the determination result. Therefore, for example, in a case where the amount of incident light is too large, the output by the light irradiation unit is adjusted, whereby the fluorescence level incident on the light receiving element can be lowered. Accordingly, even in a case where the photodiode such as APD or MPPC is adopted as the light receiving element as described above, signal saturation can be prevented. Moreover, these photodiodes are better than the PMT from the viewpoint of cost. Therefore, it is possible to appropriately acquire the fluorescence signal while reducing the cost of the biological sample analyzer.

Furthermore, in the present disclosure, the information processing unit may be configured to determine whether the information processing unit has adjusted an output of light irradiation by the light irradiation unit, and correct data related to scattered light generated by the light irradiation according to the determination result.

For example, when the laser power is changed, the levels of both the scattered light and the fluorescence acquired by the light receiving unit may be changed. The fluorescence level is desirably changed from the viewpoint of the light receiving element as described above, but the scattered light level is desirably not changed particularly on the plot data. Therefore, as described above, by performing the data correction related to the scattered light according to the determination result, it is possible to reduce the influence on the scattered light plot data due to the laser power change.

Furthermore, in the present disclosure, the information processing unit may be configured to determine whether the information processing unit has adjusted an output of light irradiation by the light irradiation unit, and adjust the compensation matrix used in the fluorescence correction according to the determination result.

Various coefficients in the compensation matrix are set on the basis of a ratio of the leakage amount of fluorescence generated from the fluorescent dye to other fluorescence channels. Here, when the laser power is changed as described above, it is also necessary to reset the compensation matrix. Therefore, as described above, by adjusting the compensation matrix according to the determination result, resetting of the compensation matrix can be automated. Therefore, it is possible to improve convenience of the device.

Hereinafter, the present disclosure will be described in more detail.

### (2) Configuration Example

FIG. 2 illustrates a configuration example of the biological sample analyzer of the present disclosure. A biological sample analyzer 6100 illustrated in FIG. 2 includes a light irradiation unit 6101 that irradiates a biological sample S flowing through a flow channel C with light, a detection unit 6102 that detects light generated by irradiating the biological sample S with light, and an information processing unit 6103 that processes information associated with information regarding the light detected by the detection unit. The biological sample analyzer 6100 is a flow cytometer or an imaging cytometer, for example. The biological sample analyzer 6100 may include a sorting unit 6104 that sorts out specific biological particles P in a biological sample. The biological sample analyzer 6100 including the sorting unit is a cell sorter, for example.

### (Biological Sample)

The biological sample S may be a liquid sample containing biological particles. The biological particles are cells or non-cellular biological particles, for example. The cells may be living cells, and more specific examples thereof include blood cells such as erythrocytes and leukocytes, and germ cells such as sperms and fertilized eggs. Also, the cells may be those directly collected from a sample such as whole blood, or may be cultured cells obtained after culturing. The non-cellular biological particles are extracellular vesicles, or particularly, exosomes and microvesicles, for example. The biological particles may be labeled with one or more labeling substances (such as a dye (particularly, a fluorescent dye) and a fluorochrome-labeled antibody). Note that particles other than biological particles may be analyzed by the biological sample analyzer of the present disclosure, and beads or the like may be analyzed for calibration or the like.

### (Flow Channel)

The flow channel C is designed so that a flow of the biological sample S is formed. In particular, the flow channel C may be designed so that a flow in which the biological particles contained in the biological sample are aligned substantially in one row is formed. The flow channel structure including the flow channel C may be designed so that a laminar flow is formed. In particular, the flow channel structure is designed so that a laminar flow in which the flow of the biological sample (a sample flow) is surrounded by the flow of a sheath liquid is formed. The design of the flow channel structure may be appropriately selected by a person skilled in the art, or a known one may be adopted. The flow channel C may be formed in a flow channel structure such as a microchip (a chip having a flow channel on the order of micrometers) or a flow cell. The width of the flow channel C is 1 mm or smaller, or particularly, may be not smaller than 10 μm and not greater than 1 mm. The flow channel C and the flow channel structure including the flow channel C may be made of a material such as plastic or glass.

The biological sample analyzer of the present disclosure is designed so that the biological sample flowing in the flow channel C, or particularly, the biological particles in the biological sample are irradiated with light from the light irradiation unit 6101. The biological sample analyzer of the present disclosure may be designed so that the irradiation point of light on the biological sample is located in the flow channel structure in which the flow channel C is formed, or may be designed so that the irradiation point is located outside the flow channel structure. An example of the former case may be a configuration in which the light is emitted onto the flow channel C in a microchip or a flow cell. In the latter case, the biological particles after exiting the flow channel structure (particularly, the nozzle portion thereof) may be irradiated with the light, and a flow cytometer of a jet-in-air type can be adopted, for example.

### (Light Irradiation Unit)

The light irradiation unit 6101 includes a light source unit that emits light, and a light guide optical system that guides the light to the irradiation point. The light source unit includes one or more light sources. The type of the light source (s) is a laser light source or an LED, for example. The wavelength of light to be emitted from each light source may be any wavelength of ultraviolet light, visible light, and infrared light. The light guide optical system includes optical components such as beam splitters, mirrors, or optical fibers, for example. The light guide optical system may also include a lens group for condensing light, and includes an objective lens, for example. There may be one or more irradiation points at which the biological sample and light intersect. The light irradiation unit 6101 may be designed to collect light emitted onto one irradiation point from one light source or different light sources.

### (Detection Unit)

The detection unit 6102 includes at least one photodetector that detects light generated by emitting light onto biological particles. The light to be detected may be fluorescence or scattered light (such as one or more of the following: forward scattered light, backscattered light, and side scattered light), for example. Each photodetector includes one or more light receiving elements, and has a light receiving element array, for example. Each photodetector may include one or more photomultiplier tubes (PMTs) and/or photodiodes such as APDs and MPPCs, as the light receiving elements. The photodetector includes a PMT array in which a plurality of PMTs is arranged in a one-dimensional direction, for example. The detection unit 6102 may also include an image sensor such as a CCD or a CMOS. With the image sensor, the detection unit 6102 can acquire an image (such as a bright-field image, a dark-field image, or a fluorescent image, for example) of biological particles.

The detection unit 6102 includes a detection optical system that causes light of a predetermined detection wavelength to reach the corresponding photodetector. The detection optical system includes a spectroscopic unit such as a prism or a diffraction grating, or a wavelength separation unit such as a dichroic mirror or an optical filter. The detection optical system is designed to disperse the light generated by light irradiation to biological particles, for example, and detect the dispersed light with a larger number of photodetectors than the number of fluorescent dyes with which the biological particles are labeled. A flow cytometer including such a detection optical system is called a spectral flow cytometer. Further, the detection optical system is designed to separate the light corresponding to the fluorescence wavelength band of a specific fluorescent dye from the light generated by the light irradiation to the biological particles, for example, and cause the corresponding photodetector to detect the separated light.

The detection unit 6102 may also include a signal processing unit that converts an electrical signal obtained by a photodetector into a digital signal. The signal processing unit may include an A/D converter as a device that performs the conversion. The digital signal obtained by the conversion performed by the signal processing unit can be transmitted to the information processing unit 6103. The digital signal can be handled as data related to light (hereinafter, also referred to as “light data”) by the information processing unit 6103. The light data may be light data including fluorescence data, for example. More specifically, the light data may be data of light intensity, and the light intensity may be light intensity data of light including fluorescence (the light intensity data may include feature quantities such as area, height, and width).

### (Information Processing Unit)

The information processing unit 6103 includes a processing unit that performs processing of various kinds of data (light data, for example), and a storage unit that stores various kinds of data, for example. In a case where the processing unit acquires the light data corresponding to a fluorescent dye from the detection unit 6102, the processing unit can perform fluorescence leakage correction (a compensation process) on the light intensity data. In the case of a spectral flow cytometer, the processing unit also performs a fluorescence separation process on the light data, and acquires the light intensity data corresponding to the fluorescent dye. The fluorescence separation process may be performed by an unmixing method disclosed in JP 2011-232259 A, for example. In a case where the detection unit 6102 includes an image sensor, the processing unit may acquire morphological information about the biological particles, on the basis of an image acquired by the image sensor. The storage unit may be designed to be capable of storing the acquired light data. The storage unit may be designed to be capable of further storing spectral reference data to be used in the unmixing process.

In a case where the biological sample analyzer 6100 includes the sorting unit 6104 described later, the information processing unit 6103 can determine whether to sort the biological particles, on the basis of the light data and/or the morphological information. The information processing unit 6103 then controls the sorting unit 6104 on the basis of the result of the determination, and the biological particles can be sorted by the sorting unit 6104.

The information processing unit 6103 may be designed to be capable of outputting various kinds of data (such as light data and images, for example). For example, the information processing unit 6103 can output various kinds of data (such as a two-dimensional plot or a spectrum plot, for example) generated on the basis of the light data. The information processing unit 6103 may also be designed to be capable of accepting inputs of various kinds of data, and accepts a gating process on a plot by a user, for example. The information processing unit 6103 may include an output unit (such as a display, for example) or an input unit (such as a keyboard, for example) for performing the output or the input.

The information processing unit 6103 may be designed as a general-purpose computer, and may be designed as an information processing device that includes a CPU, a RAM, and a ROM, for example. The information processing unit 6103 may be included in the housing in which the light irradiation unit 6101 and the detection unit 6102 are included, or may be located outside the housing. Further, the various processes or functions to be executed by the information processing unit 6103 may be realized by a server computer or a cloud connected via a network.

### (Sorting Unit)

The sorting unit 6104 performs sorting of biological particles, in accordance with the result of determination performed by the information processing unit 6103. The sorting method may be a method by which droplets containing biological particles are generated by vibration, electric charges are applied to the droplets to be sorted, and the traveling direction of the droplets is controlled by an electrode. The sorting method may be a method for sorting by controlling the traveling direction of biological particles in the flow channel structure. The flow channel structure has a control mechanism based on pressure (injection or suction) or electric charge, for example. An example of the flow channel structure may be a chip (the chip disclosed in JP 2020-76736 A, for example) that has a flow channel structure in which the flow channel C branches into a recovery flow channel and a waste liquid flow channel on the downstream side, and specific biological particles are collected in the recovery flow channel.

### (3) Laser Power Adjustment

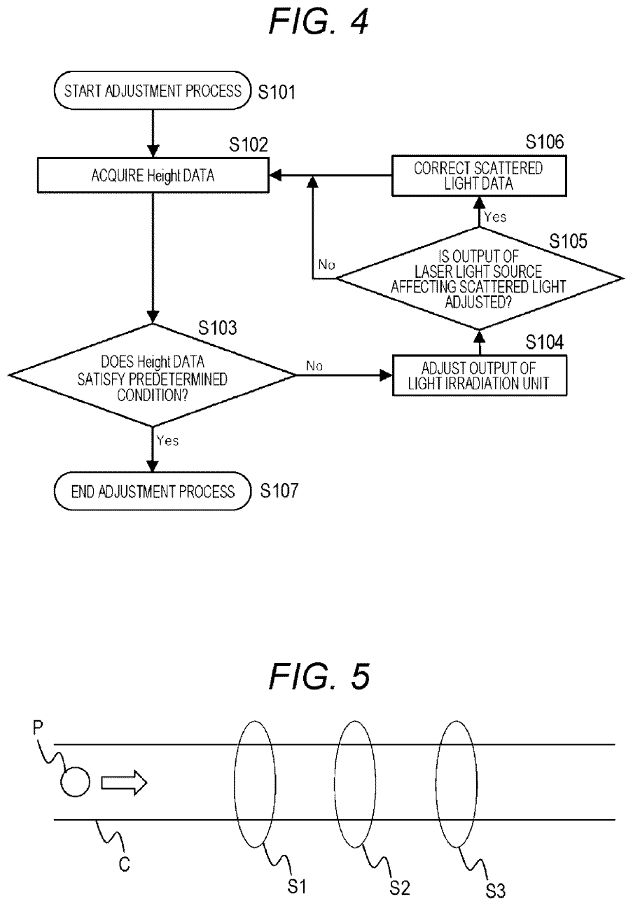

In an embodiment of the present disclosure, the information processing unit determines whether or not a detection result of fluorescence by the detection unit satisfies a predetermined condition, and adjusts an output of light irradiation by the light irradiation unit according to the determination result. An output adjustment process will be described below with reference to FIGS. 3 and 4. FIG. 3 illustrates an example of a block diagram of the biological sample analyzer according to the present disclosure. FIG. 4 illustrates an example of a flowchart of the output adjustment process executed by the biological sample analyzer.

A biological sample analyzer 100 illustrated in FIG. 3 includes a light irradiation unit 101 that irradiates a biological particle contained in a biological sample with light, a detection unit 102 that detects light generated by the light irradiation, and an information processing unit 103 that controls the light irradiation unit. The light irradiation unit 101, the detection unit 102, and the information processing unit 103 are the same as the light irradiation unit 6101, the detection unit 6102, and the information processing unit 6103 described in (2) described above.

In the present disclosure, the detection unit 102 preferably includes one or more photodiodes, preferably one or more Si photodiodes, as the light receiving element. The one or more photodiodes may include, for example, one or more APDs, one or more MPPCs, or a combination thereof. According to the present disclosure, the problem described above that may occur in such a light receiving element can be appropriately addressed.

In step S101, the information processing unit 103 starts the output adjustment process. The output adjustment process may be performed in a device setting stage before an analysis process of the biological sample by the biological sample analyzer is started, or may be performed in the middle of the analysis process of the biological sample by the biological sample analyzer.

In step S102, the biological sample analyzer 100 executes an acquisition process of acquiring the detection result of fluorescence from the biological particle for a part of the biological sample. The acquisition process may be performed so as to acquire fluorescence signals for a predetermined number of events, for example. The acquisition processing may be performed until the number of biological particles from which the fluorescence signal is acquired reaches a predetermined number. For example, the biological sample analyzer executes the acquisition process so as to acquire fluorescence signals of 1,000 events to 100,000 events, preferably 3,000 events to 80,000 events, more preferably 5,000 events to 50,000 events, and 7,000 events to 30,000 events.

In step S102, the information processing unit 103 acquires detection result data of the fluorescence. The detection result data may include Height data of fluorescence. The information processing unit 103 refers to the Height data in the fluorescence detection result acquired by the acquisition process.

The Height data is referred to for performing determination in step S103 to be described later, and is useful, for example, for determining whether the amount of incident light on the light receiving element is within the effective dynamic range.

Preferably, in step S102, the information processing unit 103 specifies a feature value of the Height data, and specifies a feature value used for signal saturation determination. The feature value may be, for example, the maximum value itself of the Height data, or may be a feature value calculated using the maximum value of the Height data. Specifying such a feature value is useful for performing the determination in step S103 to be described later.

Preferably, in step S102, the information processing unit 103 may specify the light receiving element in which the feature value of the Height data is recorded. Specifying the light receiving element is useful for appropriately adjusting the light irradiation output by the light irradiation unit. Therefore, for example, saturation of the specified light receiving element can be efficiently prevented.

The information processing unit 103 may specify the fluorescence channel in which the feature value is acquired. By specifying the fluorescence channels, the compensation matrix correction described below can be performed.

As an example, a case where the detection unit 102 includes a plurality of laser light sources is assumed. In this case, one or more fluorescence channels are associated with each laser light source in advance. For example, “one or more light receiving elements” are associated in advance with “one laser light source that emits laser light of a certain wavelength”, and each of the one or more light receiving elements is configured to detect fluorescence generated from each of one or more fluorescent dyes excited by the laser light of the wavelength.

The information processing unit 103 refers to the Height data of all the one or more fluorescence channels associated with one laser light source, and specifies the maximum value of Height (hereinafter also referred to as “Height maximum value”) from among all the pieces of the Height data. In this manner, the information processing unit 103 executes a process of specifying the Height maximum value related to fluorescence generated by light irradiation by a certain laser light source. The process can also be said to be a process in which the information processing unit 103 associates a certain laser light source with the Height maximum value of fluorescence generated by light irradiation by the laser light source.

The information processing unit 103 executes the specifying process of the Height maximum value as described above for each of the plurality of laser light sources included in the light irradiation unit 101.

By specifying the Height maximum value in this manner, the determination process in step S103 described below can be executed.

In step S103, the information processing unit 103 determines whether the detection result of the fluorescence by the detection unit satisfies the predetermined condition. Preferably, in the determination, the information processing unit determines whether the Height data in the detection result of the fluorescence satisfies the predetermined condition. Executing the determination on the basis of the Height data is particularly useful for adjusting the output of the light irradiation unit so as to prevent the saturation of the light receiving element. Preferably, the detection unit includes a plurality of fluorescence channels, and the information processing unit refers to the Height data of the fluorescence channel from which the maximum Height value is obtained from among the plurality of fluorescence channels, in the determination.

In the preferred embodiment, the information processing unit 103 may refer to the feature value of the Height data, particularly, the feature value used for the signal saturation determination, and determine whether the feature value satisfies the predetermined condition. The feature value is as described above with respect to step S102, and may be, for example, the maximum value of the Height data.

The predetermined condition may be a condition set on the basis of a condition in which signal saturation occurs in the detection unit. The predetermined condition may be appropriately set by a person skilled in the art so as to prevent the saturation of the light receiving element. An example of the predetermined condition will be described below.

For example, the predetermined condition may be a condition that “the feature value (in particular, the Height maximum value) is within ±X % of a predetermined target value”. In this case, it is determined whether the feature value is within a numerical value range of (target value−target value×X %) to (target value+target value×X %).

Here, X may be appropriately set by a person skilled in the art, and may be, for example, any numerical value of 1 to 40, preferably 2 to 30, and more preferably 5 to 20. For example, in a case where X is 10, the predetermined condition is that “the feature value (in particular, the Height maximum value) is within +10% of a predetermined target value”. Furthermore, the target value may be set according to a dynamic range and/or a noise range of the light receiving element, for example.

Note that, in a case where X is too small, the possibility that it takes too long to adjust the output is increased. Furthermore, in a case where X is too large, the possibility that the fluorescence level is not appropriately adjusted is increased.

Regarding the predetermined condition set in this manner, for example, in a case where the feature value is higher than (the target value+the target value×X %), the possibility of saturation of the light receiving element is increased. Therefore, the possibility of saturation can be reduced by executing the output adjustment in step S104 described later.

Furthermore, regarding the predetermined condition set in this manner, for example, in a case where the feature value is lower than (the target value−the target value×X %), the possibility of saturation of the light receiving element is low, but the possibility that the fluorescence level is too low is increased. Therefore, the detected fluorescence level is adjusted to an appropriate level by executing the output adjustment in step S104 described later.

As described above, such conditions are useful for obtaining an appropriate fluorescence level.

Furthermore, the predetermined condition may be a condition that “the feature value (in particular, the Height maximum value) is within +Y % of a predetermined target value”. In this case, it is determined whether the feature value is within a numerical value range of (target value−Y) to (target value+Y).

Here, Y is, for example, 1,000 to 100,000, preferably 5,000 to 50,000, and more preferably any numerical value of 10,000 to 30,000. As described above, instead of the numerical range defined by the percentage, the predetermined condition may be defined by the numerical value itself.

In a case where it is determined in step S103 that the predetermined condition is not satisfied, the information processing unit 103 advances the process to step S104. In a case where it is determined that the predetermined condition is satisfied, the information processing unit 103 advances the process to step S107.

In step S104, the information processing unit 103 executes the output adjustment process of the light irradiation unit 101. Preferably, the information processing unit adjusts the output of light irradiation by the light irradiation unit such that saturation of the signal does not occur in the detection unit, and more specifically, the information processing unit adjusts the output of light irradiation by the light irradiation unit on the basis of the Height data in the detection result of the fluorescence.

The information processing unit performs the output adjustment process on the laser light source associated with the fluorescence channel from which the Height data determined not to satisfy the predetermined condition in step S103 is obtained.

### (Adjustment Coefficient)

Preferably, in the output adjustment process, an adjustment coefficient set on the basis of the feature value and the target value may be used. The information processing unit may adjust the laser power of the laser light source as a target of the output adjustment process, using the adjustment coefficient. The adjustment coefficient makes it possible to adjust the output of the laser light source so as to prevent saturation.

For example, the adjustment coefficient may be “(the target value)/(the feature value)”. For example, in a case where the feature value is the Height maximum value, the adjustment coefficient is “(the target value)/(the Height maximum value)”.

The information processing unit may adjust the laser power before the adjustment using the adjustment coefficient, and in particular, may perform a process of multiplying the laser power before the adjustment by the adjustment coefficient.

As described above, in the preferred embodiment of the present disclosure, the information processing unit adjusts the output of the light irradiation by the light irradiation unit using the adjustment coefficient set on the basis of the Height data in the detection result of the fluorescence and the predetermined target value.

### (Laser Light Source as Adjustment Target)

As described above, the laser light source as a target of the output adjustment is the laser light source associated with the fluorescence channel from which the Height data determined not to satisfy the predetermined condition in step S103 is obtained.

Here, in a case where the light irradiation unit includes two or more laser light sources, a laser light source as a target of the output adjustment and a method of the output adjustment may be changed according to an irradiation method of a laser light group from the two or more laser light sources.

For example, the light irradiation unit may include two or more laser light sources for coaxial irradiation. In this case, the information processing unit may adjust the outputs of the two or more laser light sources for coaxial irradiation using the same adjustment coefficient. Therefore, the composition ratios of the outputs of the two or more laser light sources are stored before and after the adjustment.

Furthermore, the light irradiation unit may include two or more laser light sources for irradiation with different axes. In this case, the information processing unit adjusts the outputs of the two or more laser light sources for irradiation with the different axes independently of each other. The two or more laser light sources for irradiation with different axes may not have the same composition ratio of the output before and after the adjustment, and can appropriately adjust the output of the laser light irradiated to each axis by being adjusted independently.

The above output adjustment will be described below with reference to FIG. 5.

In the figure, a flow channel C through which a particle P as an analysis target flows is illustrated. As illustrated in the figure, three spots S1, S2, and S3 irradiated with the laser light are present in the flow channel C.

Among the spots, the spot S1 is coaxially irradiated with the laser light emitted from each of the two laser light sources, which corresponds to a case where the light irradiation unit includes two or more laser light sources for coaxial irradiation. Regarding the fluorescence channel associated with one laser light source of the two laser light sources, a case is assumed where it is determined in step S103 that the predetermined condition is not satisfied. In this case, the information processing unit adjusts the output of the one laser light source using the adjustment coefficient as described above. Moreover, the information processing unit adjusts the output of the other laser light source of the two laser light sources using the same adjustment coefficient. In this manner, the same adjustment coefficient may be used for adjusting the output of the laser light source group for coaxial irradiation.

Furthermore, the spot S2 is irradiated with one laser beam from one laser light source, and the spot S3 is irradiated with one laser beam from the other laser light source. This corresponds to a case where the light irradiation unit includes two or more laser light sources for irradiation with different axes. Regarding the fluorescence channel associated with one laser light source of the two laser light sources, a case is assumed where there are two fluorescence channels determined not to satisfy the predetermined condition in step S103, and the two fluorescence channels are respectively associated with these two laser light sources. In this case, the information processing unit specifies adjustment coefficients independently of each other for each fluorescence channel, that is, obtains two adjustment coefficients. The information processing unit adjusts the output of each laser light source associated with each fluorescence channel by using these two adjustment coefficients. In this manner, a plurality of adjustment coefficients acquired independently of each other may be used for adjusting the output of the laser light source group for irradiation with different axes.

In step S104, after the output adjustment process is completed, the information processing unit advances the process to step S105.

In step S105, the information processing unit 103 determines whether the information processing unit has adjusted the output of the laser light source included in the light irradiation unit. The laser light source as a determination target may be any one or more of the plurality of laser light sources included in the light irradiation unit, and may be, for example, a laser light source that emits laser light for generating scattered light as the detection target. The laser light source that emits laser light for generating fluorescence may also be assigned as the laser light source that emits laser light for generating scattered light as the detection target.

In order to execute the determination, which of the laser light sources included in the light irradiation unit is the determination target laser light source may be specified in advance. The laser light source may be specified by, for example, a wavelength of emitted laser light. For example, a laser light source that emits laser light having a wavelength of 400 nm to 500 nm, in particular, a laser light source that emits laser light having a wavelength of 488 nm may be specified in advance as the determination target laser light source.

In step S105, for example, the information processing unit 103 determines whether or not the laser light source of which the output has been adjusted in step S104 is the laser light source as the determination target.

In a case where the laser light source of which the output has been adjusted is the laser light source as the determination target, the information processing unit determines that the output of the laser light source that emits laser light for generating scattered light has been adjusted, and advances the process to step S106.

In a case where the laser light source of which the output has been adjusted is not assigned as the laser light source as the determination target, the information processing unit determines that the output of the laser light source that emits laser light for generating scattered light has not been adjusted, and returns the process to step S102.

In step S106, the information processing unit 103 corrects data related to scattered light generated by the light irradiation.

By adjusting the output of the laser light, the fluorescence level is adjusted, and saturation of the light receiving element is avoided. The output adjustment of the laser light also changes the scattered light level, but in some cases, it may be desirable that the plot data related to the scattered light (in particular, the position of the plot) is not changed before and after the adjustment of the output of the laser light.

In the present disclosure, the information processing unit may determine whether the information processing unit has adjusted the output of the laser light source included in the light irradiation unit in step S105, and may correct data related to scattered light generated by the light irradiation in step S106 according to the determination result. The plot data related to the scattered light is also corrected by the correction. Therefore, it is possible to suppress a change in the plot data related to the scattered light before and after the adjustment of the output of the laser light. The scattered light may be, for example, one, two, or all three of forward scattered light, side scattered light, and backscattered light. The plot data may be, for example, two-dimensional plot data obtained by respectively plotting data related to any two types of scattered light among the three types of scattered light on the X axis and the Y axis, or one-dimensional plot data obtained by plotting data related to one type of scattered light with respect to the number of events.

In one embodiment of the present disclosure, the data related to the scattered light as the correction target may include Area data, Height data, or both the Area data and the Height data of the scattered light generated by the light irradiation. By correcting these pieces of data, a change in the plot data before and after the output adjustment is suppressed.

In this embodiment, a correction coefficient set on the basis of laser power before the output adjustment and laser power after the output adjustment of any laser light source included in the light irradiation unit may be used to correct the data related to the scattered light. More specifically, the correction coefficient may be a correction coefficient set on the basis of laser power before the output adjustment and laser power after the output adjustment of the laser light source as the target of the output adjustment process, and may be, for example, an inverse ratio of (laser power before the output adjustment of the laser light source)/(laser power after the output adjustment of the laser light source).

By plotting data corrected by multiplying the Area data, the Height data, or both the Area data and the Height data of scattered light by such a correction coefficient, it is possible to suppress a change in the plot data before and after the output adjustment process.

In another embodiment of the present disclosure, the data related to the scattered light as the correction target may be Threshold data for specifying the biological particle as the analysis target. Even in a case where the Threshold data is corrected, a change in the plot data before and after the output adjustment is suppressed.

In this embodiment, a correction coefficient set on the basis of laser power before the output adjustment and laser power after the output adjustment of any laser light source included in the light irradiation unit may be used to correct the data related to the scattered light. More specifically, the correction coefficient may be a correction coefficient set on the basis of laser power before the output adjustment and laser power after the output adjustment of the laser light source as the target of the output adjustment process, and may be, for example, a ratio of (laser power before the output adjustment of the laser light source)/(laser power after the output adjustment of the laser light source) or an inverse ratio thereof. Which one of the ratio and the inverse ratio is adopted may be appropriately changed according to the timing of data process.

By plotting data corrected by multiplying the Threshold data by such a correction coefficient, the trigger is applied at a ratio similar to that before the laser power is lowered, and a change in the plot data before and after the output adjustment process can be suppressed.

Note that, in a case where the Area data, the Height data, or both the Area data and the Height data of the scattered light are corrected, the Threshold data may not be corrected. By correcting any one of the Area data, the Height data, both the Area data and the Height data, or the Threshold data of the scattered light, the change in the plot data is appropriately suppressed.

As described in the above two embodiments, the information processing unit may correct the data related to the scattered light using the correction coefficient set on the basis of laser power before the output adjustment and laser power after the output adjustment of any laser light source included in the light irradiation unit.

The correction process in step S106 may be executed, for example, at a stage where the scattered light plot data is output by a graphical user interface (GUI), or may be executed before the scattered light plot data is output by the GUI.

In the former case, for example, the correction process may not be performed inside the firmware (FW). The output unit receives the data related to scattered light before the correction process is executed, the output unit executes the correction process, and then the output unit outputs scattered light data after the correction process.

In the latter case, the correction process is executed inside the FW. The data related to the scattered light after the correction process is executed is transmitted to the output unit, and then the output unit outputs the scattered light data after the correction process.

After the correction process in step S106, the information processing unit returns the process to step S102.

In step S107, the information processing unit 103 ends the output adjustment process.

By executing the output adjustment process as described above, the output of the light irradiation unit is adjusted so as to prevent saturation of the light receiving element.

Furthermore, as is clear from the flowchart described above, steps S102 to S106 may be repeated. As a result, in a case where the Height data does not satisfy the predetermined condition even when the output adjustment process in step S104 is executed, the output adjustment process is executed again. By repeating steps S102 to S106 by the information processing unit, the output adjustment is appropriately performed.

### (4) Example 1 of Adjustment Process of Laser Power

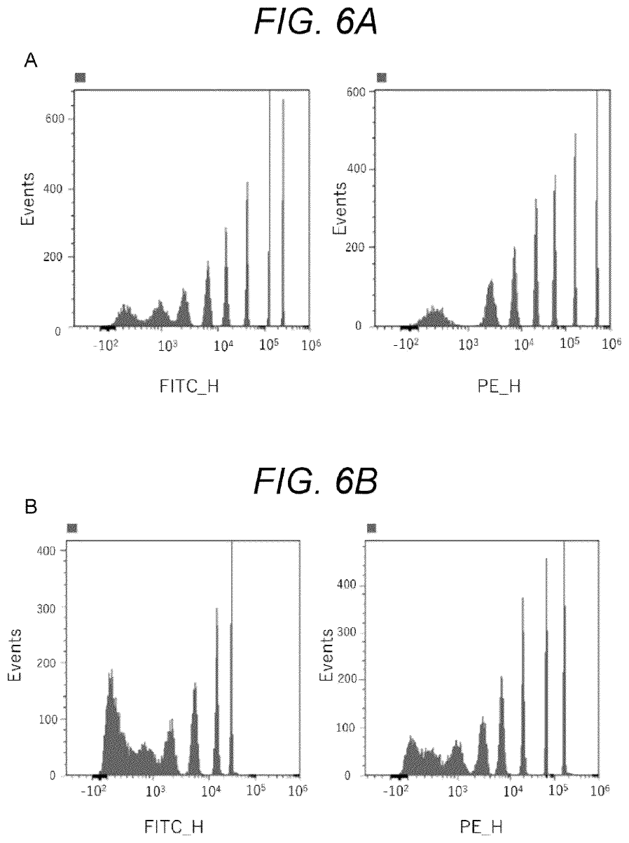

A flow cytometer equipped with a light irradiation unit having a laser light source having a wavelength of 488 nm was prepared. The flow cytometer had a detection unit including a FITC channel and a PE channel. The flow cytometer was caused to execute the output adjustment process described in (3) described above using a cell-containing sample stained with FITC and PE. In the output adjustment process, 2×10⁵ was adopted as the target value. Furthermore, the predetermined condition was a condition that “the Height maximum value is within ±10% of the target value”. In the output adjustment process, laser power of the laser light source having a wavelength of 488 nm was adjusted. FIG. 6A illustrates data output before the adjustment, and FIG. 6B illustrates data output after the adjustment.

Before the adjustment, the signal was saturated in the PE channel as illustrated in FIG. 6A. The Height maximum value in the PE channel exceeded 2×10⁵ and was saturated at 1×10⁶.

After the adjustment, as illustrated in FIG. 6B, it was confirmed that the Height maximum value in the PE channel was in the vicinity of 2×10⁵.

As described above, by executing the output adjustment process according to the present disclosure, the output of the light irradiation unit can be adjusted so as to avoid the signal saturation.

### (5) Example 2 of Adjustment Process of Laser Power

Hereinafter, an example of a change in fluorescence plot data and an example of suppression of a change in scattered light plot data in a case where the output adjustment process described in (3) described above is executed will be described.

A flow cytometer having two laser light irradiation axes was prepared. The flow cytometer included three laser light sources, and the wavelengths of the laser light emitted from these laser light sources were 488 nm, 561 nm, and 638 nm, respectively. The flow cytometer had two laser light irradiation axes. A first irradiation axis (hereinafter referred to as a “first axis”) is coaxially irradiated with laser light having a wavelength of 488 nm and laser light having a wavelength of 561 nm. The other irradiation axis (hereinafter referred to as a “second axis”) is irradiated with laser light having a wavelength of 638 nm.

The flow cytometer was caused to execute the output adjustment process described in (3) described above, and the laser power of the two laser light sources (488 nm and 561 nm) with which the first axis was irradiated was reduced to 1/10. On the other hand, for the laser light source (638 nm) that irradiates the second axis with the laser light, the output of the laser light source was not adjusted. Specific laser power was as follows.
Before execution of the output adjustment process: 488 nm:561 nm:638 nm=50 mW:50 mW:50 mW
After execution of the output adjustment process: 488 nm:561 nm:638 nm=5 mW:5 mW:50 mW

Furthermore, one of the laser light sources irradiating the first axis on which the output adjustment process was performed with the laser light emitted the laser light of 488 nm. The laser light source is a laser light source that emits laser light that generates scattered light as the detection target. Therefore, the scattered light data correction process described in (3) described above was also performed.

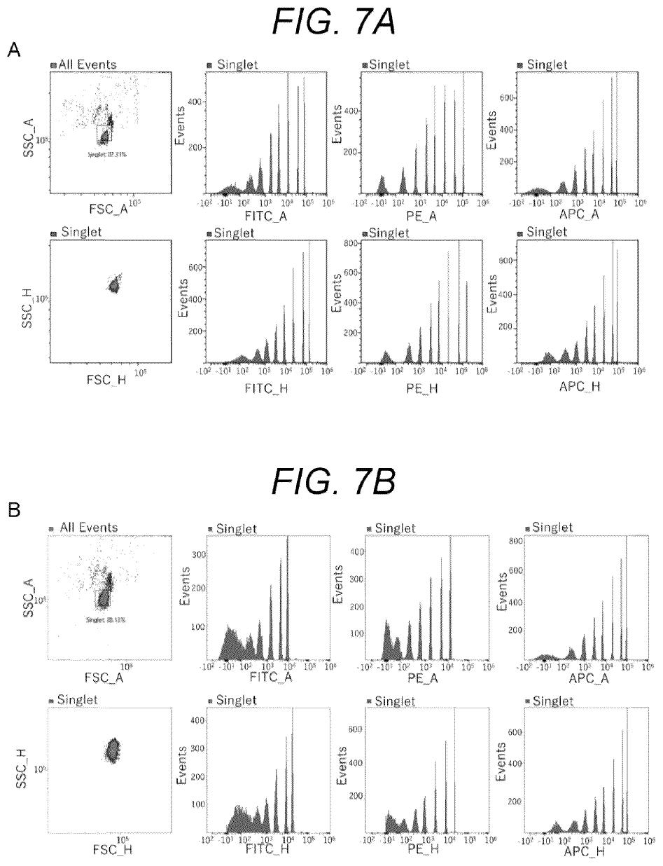

FIG. 7A illustrates the plot data before the output adjustment process is executed, and FIG. 7B illustrates the plot data after the output adjustment process is executed. As can be seen from these figures, the fluorescence level of the fluorescence (FITC and PE) detected by the fluorescence channel of the first axis was lowered by the output adjustment process. On the other hand, the fluorescence level of the fluorescence (APC) detected by the fluorescence channel of the second axis was not changed before and after the output adjustment process.

Furthermore, the first axis is irradiated with the laser light of 488 nm, and this laser light is also laser light that generates scattered light as the detection target. Although the laser power of the laser light has dropped to 1/10, the scattered light data is displayed at the same position in the two-dimensional scattered light plot (plot data having axes of SSC (side scattered light) and FSC (forward scattered light)) by executing the scattered light data correction process as described above.

### (6) Example 3 of Adjustment Process of Laser Power

In the flow cytometer referred to in (5) described above, the output adjustment process described in (3) described above was executed, and the laser power of the laser light source (638 nm) with which the second axis was irradiated was reduced to 1/10. On the other hand, the outputs of the laser light sources were not adjusted for the two laser light sources (488 nm and 561 nm) with which the first axis was irradiated. Specific laser power was as follows.
Before execution of the output adjustment process: 488 nm:561 nm:638 nm=50 mW:50 mW:50 mW
After execution of the output adjustment process: 488 nm: 561 nm: 638 nm=50 mW: 50 mW: 5 mW

Furthermore, the laser light source that irradiates the second axis on which the output adjustment processing has been performed with the laser light is not a laser light source that emits laser light that generates scattered light as the detection target. Therefore, the scattered light data correction process described in (3) described above was not performed.

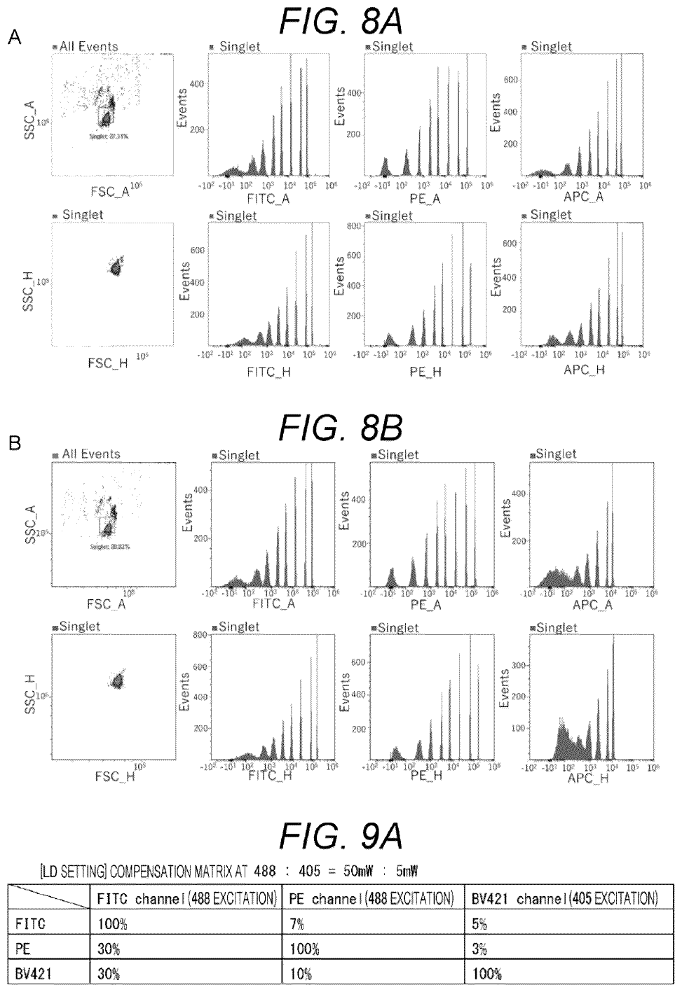

FIG. 8A illustrates the plot data before the output adjustment process is executed, and FIG. 8B illustrates the plot data after the output adjustment process is executed. As can be seen from these figures, the fluorescence level of the fluorescence (APC) detected by the fluorescence channel of the second axis was lowered by the output adjustment process. On the other hand, the fluorescence level of the fluorescence (FITC and PE) detected by the fluorescence channel of the first axis was not changed before and after the output adjustment process.

Furthermore, the laser light of the second axis is not laser light that generates scattered light as the detection target. Therefore, the scattered light data correction process was not executed. In the two-dimensional scattered light plot (plot data having axes of SSC and FSC), the scattered light plot data is displayed at the same position before and after the output adjustment process.

### (7) Adjustment of Compensation Matrix Executed with Laser Power Adjustment

In one embodiment of the present disclosure, the information processing unit determines whether the information processing unit has adjusted an output of light irradiation by the light irradiation unit, and adjusts the compensation matrix used in the fluorescence correction according to the determination result.

The adjustment of the laser power of the laser light source results in a change in the fluorescence level as described above. Therefore, in a case where the laser power of the laser light source is adjusted, more appropriate fluorescence correction can be performed by also correcting a compensation matrix used to correct leakage of the fluorescence. Furthermore, since the amount of change in the fluorescence level can be calculated on the basis of the amount of change in the laser power, the adjustment process of the compensation matrix described above can be automatically executed.

For example, regarding two or more fluorescent dyes excited by the same laser light, a relative ratio of the fluorescence levels generated from each of the two or more fluorescent dyes is not changed. Therefore, the same compensation value may be used between the two or more fluorescent dyes before and after the adjustment of the laser power.

On the other hand, regarding two or more fluorescent dyes excited by different laser beams, the compensation value used for fluorescence correction may be adjusted by a change ratio of the laser power.

In one embodiment of the present disclosure, the information processing unit adjusts one or more compensation values in the compensation matrix by using a change coefficient set on the basis of laser power before output adjustment and laser power after output adjustment of any laser light source included in the light irradiation unit.

The change coefficient may be, for example, a ratio set on the basis of the laser power before the output adjustment and the laser power after the output adjustment, and is, for example, a ratio of (laser power after the output adjustment)/(laser power before the output adjustment) or an inverse ratio thereof (laser power before the output adjustment)/(laser power after the output adjustment).

Furthermore, the information processing unit may not perform adjustment using the change coefficient on the compensation value related to a pair of two fluorescent dyes using the laser light source on which the output adjustment has been performed as excitation light. This is because, as described above, the relative ratio of the fluorescence levels generated from each of two or more fluorescent dyes excited by the same laser light is not changed.

In the present disclosure, the information processing unit may be configured to execute the adjustment using the change coefficient on the compensation value related to a pair of one fluorescent dye using a laser light source on which the output adjustment has been performed as excitation light and one fluorescent dye using a laser light source on which the output adjustment has not been performed as excitation light and/or the compensation value related to a pair of two fluorescent dyes using a laser light source on which the output adjustment has not been performed as excitation light.

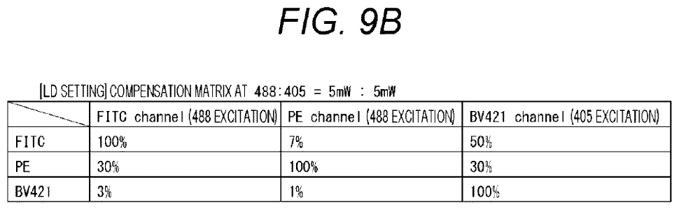

Hereinafter, an example of adjustment of the compensation matrix will be described with reference to FIGS. 9A and 9B. The compensation matrix related to the three fluorescent dyes (FITC, PE, and BV421) is illustrated in Table 1 below. FITC and PE are excited by laser light having a wavelength of 488 nm. BV421 is excited by laser light of 405 nm.

FIG. 9A illustrates the compensation matrix before the adjustment. The compensation matrix illustrated in this figure is a matrix at laser power of 488 nm: laser power of 405 nm=50 mW: 5 mW. As illustrated in the figure, a compensation value is set for each pair of fluorescent dyes.

For example, the compensation value for correcting leakage of the fluorescence generated from the FITC into the PE channel is 7%, and the compensation value for correcting leakage of the fluorescence generated from the FITC into the BV421 channel is 5%.

As described above, in the compensation matrix, a compensation value for the correction of leakage of the fluorescence from another fluorescent dye into a fluorescence channel allocated to a certain fluorescent dye is set.

Here, it is assumed that the laser power of laser light source of the 488 nm is changed to 1/10 by the output adjustment process described in (3) described above. That is, LD488:LD405=5 mW: 5 mW. In this case, the adjustment coefficient is, for example, 1/10 or 10. The compensation matrix is adjusted using the adjustment coefficient. FIG. 9B illustrates the compensation matrix after the adjustment.

For example, FITC and PE are excited by the same laser light. Therefore, the compensation value for correcting leakage of the fluorescence generated from FITC into the PE channel is not changed. On the other hand, the laser light for exciting the BV421 is different from the laser light for exciting the FITC. Therefore, the compensation value for correcting leakage of the fluorescence generated from FITC into the BV421 channel is changed. The change is a change to be multiplied by the adjustment coefficient 10, and the compensation value is changed to 50%.

Similarly, the compensation value for correcting leakage of the fluorescence generated from PE into the FITC channel is not changed. On the other hand, the compensation value for correcting leakage of the fluorescence generated from PE into the BV421 channel is changed. The change is a change to be multiplied by the adjustment coefficient 10, and the compensation value is changed to 30%.

The laser light for exciting the BV421 is different from the laser light for exciting the FITC and PE. Therefore, the compensation value for correcting leakage of the fluorescence generated from the BV421 into the FITC channel is changed. The change is a change to be multiplied by the adjustment coefficient 1/10, and the compensation value is changed to 3%.

Furthermore, the compensation value for correcting leakage of the fluorescence generated from the BV421 into the PE channel is also similarly changed. The change is a change to be multiplied by the adjustment coefficient 1/10, and the compensation value is changed to 1%.

The information processing unit performs the fluorescence correction using the compensation matrix adjusted as described above.

Note that, the present disclosure can also have the following configurations.

[1]

A biological sample analyzer including:
a light irradiation unit that irradiates a biological particle contained in a biological sample with light;
a detection unit that detects light generated by the light irradiation; and
an information processing unit that controls the light irradiation unit,
in which the information processing unit determines whether a detection result of fluorescence by the detection unit satisfies a predetermined condition, and adjusts an output of light irradiation by the light irradiation unit according to the determination result.

[2]

The biological sample analyzer described in [1],
in which the detection unit includes one or more photodiodes, and
the information processing unit adjusts the output of light irradiation by the light irradiation unit such that saturation of a signal does not occur in the detection unit.

[3]

The biological sample analyzer described in [1] or [2],
in which the information processing unit adjusts the output of light irradiation by the light irradiation unit on the basis of Height data in the detection result of the fluorescence.

[4]

The biological sample analyzer described in any one of [1] to [3],
in which the information processing unit adjusts the output of light irradiation by the light irradiation unit using an adjustment coefficient set on the basis of Height data in the detection result of the fluorescence and a predetermined target value.

[5]

The biological sample analyzer described in any one of [1] to [4],
in which the light irradiation unit includes two or more laser light sources for coaxial irradiation, and the information processing unit adjusts outputs of the two or more laser light sources for coaxial irradiation, using a same adjustment coefficient.

[6]

The biological sample analyzer described in any one of [1] to [5],
in which the light irradiation unit includes two or more laser light sources for irradiation with different axes, and
the information processing unit adjusts outputs of the two or more laser light sources for irradiation with the different axes independently of each other.

[7]

The biological sample analyzer described in any one of [1] to [6],
in which the detection unit includes one or more photodiodes, and
the predetermined condition is a condition set on the basis of a condition where saturation of a signal occurs in the detection unit.

[8]

The biological sample analyzer described in any one of [1] to [7],
in which, in the determination, the information processing unit determines whether Height data in the detection result of the fluorescence satisfies the predetermined condition.

[9]

The biological sample analyzer described in [8],
in which the detection unit includes a plurality of fluorescence channels, and
the information processing unit refers to Height data of a fluorescence channel from which a maximum Height value is obtained from among the plurality of fluorescence channels, in the determination.

[10]

The biological sample analyzer described in any one of [1] to [9],
in which the information processing unit determines whether the information processing unit has adjusted the output of the laser light source included in the light irradiation unit, and corrects data related to scattered light generated by the light irradiation according to the determination result.

[11]

The biological sample analyzer described in [10],
in which the data related to the scattered light includes Area data, Height data, or both the Area data and Height data of the scattered light generated by the light irradiation.

[12]

The biological sample analyzer described in or [11],
in which the data related to the scattered light includes Threshold data for specifying a biological particle as an analysis target.

[13]

The biological sample analyzer described in any one of to [12],
in which the information processing unit corrects the data related to the scattered light using a correction coefficient set on the basis of laser power before output adjustment and laser power after output adjustment of any laser light source included in the light irradiation unit.

[14]

The biological sample analyzer described in any one of [1] to [13],
in which the information processing unit determines whether the information processing unit has adjusted the output of the light irradiation by the light irradiation unit, and adjusts a compensation matrix used in fluorescence correction according to the determination result.

[15]

The biological sample analyzer described in [14],
in which the information processing unit adjusts one or more compensation values in the compensation matrix by using a change coefficient set on the basis of laser power before output adjustment and laser power after output adjustment of any laser light source included in the light irradiation unit.

[16]

The biological sample analyzer described in [15],
in which the information processing unit does not perform the adjustment for a compensation value related to a pair of two fluorescent dyes using a laser light source on which output adjustment has been performed as excitation light.

[17]

The biological sample analyzer described in or [16],
in which the information processing unit executes the adjustment on
a compensation value related to a pair of one fluorescent dye using a laser light source on which the output adjustment has been performed as excitation light and one fluorescent dye using a laser light source on which the output adjustment has not been performed as excitation light and/or
a compensation value related to a pair of two fluorescent dyes using a laser light source on which the output adjustment has not been performed as excitation light.

### REFERENCE SIGNS LIST

100 Biological sample analyzer
101 Light irradiation unit
102 Detection unit
103 Information processing unit

1. A biological sample analyzer comprising:
a light irradiation unit that irradiates a biological particle contained in a biological sample with light;
a detection unit that detects light generated by the light irradiation; and
an information processing unit that controls the light irradiation unit,
wherein the information processing unit determines whether a detection result of fluorescence by the detection unit satisfies a predetermined condition, and adjusts an output of light irradiation by the light irradiation unit according to the determination result.

2. The biological sample analyzer according to claim 1,
wherein the detection unit includes one or more photodiodes, and
the information processing unit adjusts the output of light irradiation by the light irradiation unit such that saturation of a signal does not occur in the detection unit.

3. The biological sample analyzer according to claim 1,
wherein the information processing unit adjusts the output of light irradiation by the light irradiation unit on a basis of Height data in the detection result of the fluorescence.

4. The biological sample analyzer according to claim 1,
wherein the information processing unit adjusts the output of light irradiation by the light irradiation unit using an adjustment coefficient set on a basis of Height data in the detection result of the fluorescence and a predetermined target value.

5. The biological sample analyzer according to claim 1,
wherein the light irradiation unit includes two or more laser light sources for coaxial irradiation, and
the information processing unit adjusts outputs of the two or more laser light sources for coaxial irradiation, using a same adjustment coefficient.

6. The biological sample analyzer according to claim 1,
wherein the light irradiation unit includes two or more laser light sources for irradiation with different axes, and
the information processing unit adjusts outputs of the two or more laser light sources for irradiation with the different axes independently of each other.

7. The biological sample analyzer according to claim 1,
wherein the detection unit includes one or more photodiodes, and
the predetermined condition is a condition set on a basis of a condition where saturation of a signal occurs in the detection unit.

8. The biological sample analyzer according to claim 1,
wherein, in the determination, the information processing unit determines whether Height data in the detection result of the fluorescence satisfies the predetermined condition.

9. The biological sample analyzer according to claim 8,
wherein the detection unit includes a plurality of fluorescence channels, and
the information processing unit refers to Height data of a fluorescence channel from which a maximum Height value is obtained from among the plurality of fluorescence channels, in the determination.

10. The biological sample analyzer according to claim 1,
wherein the information processing unit determines whether the information processing unit has adjusted the output of the laser light source included in the light irradiation unit, and corrects data related to scattered light generated by the light irradiation according to the determination result.

11. The biological sample analyzer according to claim 10,
wherein the data related to the scattered light includes Area data, Height data, or both the Area data and Height data of the scattered light generated by the light irradiation.

12. The biological sample analyzer according to claim 10,
wherein the data related to the scattered light includes Threshold data for specifying a biological particle as an analysis target.

13. The biological sample analyzer according to claim 10,
wherein the information processing unit corrects the data related to the scattered light using a correction coefficient set on a basis of laser power before output adjustment and laser power after output adjustment of any laser light source included in the light irradiation unit.

14. The biological sample analyzer according to claim 1,
wherein the information processing unit determines whether the information processing unit has adjusted the output of the light irradiation by the light irradiation unit, and adjusts a compensation matrix used in fluorescence correction according to the determination result.

15. The biological sample analyzer according to claim 14,
wherein the information processing unit adjusts one or more compensation values in the compensation matrix by using a change coefficient set on a basis of laser power before output adjustment and laser power after output adjustment of any laser light source included in the light irradiation unit.

16. The biological sample analyzer according to claim 15,
wherein the information processing unit does not perform the adjustment for a compensation value related to a pair of two fluorescent dyes using a laser light source on which output adjustment has been performed as excitation light.

17. The biological sample analyzer according to claim 15,
wherein the information processing unit executes the adjustment on
a compensation value related to a pair of one fluorescent dye using a laser light source on which the output adjustment has been performed as excitation light and one fluorescent dye using a laser light source on which the output adjustment has not been performed as excitation light and/or
a compensation value related to a pair of two fluorescent dyes using a laser light source on which the output adjustment has not been performed as excitation light.
